(19) United States
(12) Patent Application Publication
(10) Pub. No.: US 2026/0290785 A1
(43) Pub. Date: Sep. 24, 2026

(54) POSITIVE ELECTRODE, SOLID STATE BATTERY AND MANUFACTURING METHOD OF SOLID STATE BATTERY

(71) Applicant: HONDA MOTOR CO., LTD., Tokyo (JP)

(72) Inventors: Kiyoshi TANAAMI, Saitama (JP); Hiroshi SAKAI, Saitama (JP); Toshimitsu TANAKA, Saitama (JP)

(21) Appl. No.: 19/061,283

(22) Filed: Feb. 24, 2025

(30) Foreign Application Priority Data
Mar. 18, 2024 (JP) 2024-041991

(51) Int. Cl. H01M 4/131; H01M 4/02; H01M 4/04; H01M 4/1391; H01M 4/36; H01M 4/38; H01M 4/505

(52) U.S. Cl. CPC H01M 4/131; H01M 4/0404; H01M 4/1391; H01M 4/366; H01M 4/382; H01M 4/505; H01M 2004/021; H01M 2004/028

(57) ABSTRACT

A positive electrode of a solid state battery includes: a positive electrode mixture layer provided by filling pores of a metal porous body with a positive electrode mixture containing a positive electrode active material, a solid electrolyte, and a conductive auxiliary agent, wherein the positive electrode mixture layer includes a first layer and a second layer provided closer to the solid electrolyte layer than the first layer is, and a mass fraction of the conductive auxiliary agent contained in the second layer to a mass of the positive electrode mixture contained in the second layer is greater than a mass fraction of the conductive auxiliary agent contained in the first layer to a mass of the positive electrode mixture contained in the first layer.

### BACKGROUND

### Technical Field

The present invention relates to a positive electrode, a solid state battery, and a manufacturing method of a solid state battery.

### Related Art

Recently, research and development on secondary batteries that contribute to energy efficiency has been conducted in order for more people to be able to access affordable, reliable, sustainable, and advanced energy. The solid state batteries are high in energy density, and are used in a wide range of applications. In particular, lithium ion secondary batteries are becoming increasingly important as power sources for electric vehicles (EVs), hybrid electric vehicles (HEVs), and the like.

As a configuration of a solid state battery, a configuration using lithium as a negative electrode of a lithium secondary battery in order to increase a capacity is known. In this regard, JP 2023-142796 A discloses that the negative electrode contains lithium, and the through hole of the current collector in the positive electrode is filled with a positive electrode active material and a conductive auxiliary agent. The positive electrode mixture layer in JP 2023-142796 A occludes lithium ions.

### CITATION LIST

### Patent Literature

Patent Literature 1: JP 2023-142796 A

### SUMMARY

In order to contribute to further improvements in energy efficiency, the solid state batteries are also demanded to be capable of maintaining the battery lives, also when charging and discharging are repeated. Examples of required characteristics for this include control of a structural change of the positive electrode such as a volume change of the positive electrode active material that accompanies occlusion of lithium ions and the like by the positive electrode active material when charging and discharging of the solid state battery are repeated. When the volume of the positive electrode active material changes, a gap is likely to be provided between layers, so that the resistance of the solid state battery may increase, and the movement path of electrons may decrease. In particular, in the positive electrode having a high capacity, a volume change of the positive electrode active material may easily occur.

Under such a background, an object of the present invention is to provide a positive electrode which is hardly affected by a volume change of a positive electrode active material when the positive electrode is used as a solid state battery. This ultimately contributes to energy efficiency.

In order to achieve the above object, a positive electrode according to claim 1 of the present invention is a positive electrode of a solid state battery, the positive electrode including: a positive electrode mixture layer provided by filling pores of a metal porous body with a positive electrode mixture containing a positive electrode active material, a solid electrolyte, and a conductive auxiliary agent, wherein the positive electrode mixture layer includes a first layer and a second layer provided closer to the solid electrolyte layer than the first layer is, and a mass fraction of the conductive auxiliary agent contained in the second layer to a mass of the positive electrode mixture contained in the second layer is greater than a mass fraction of the conductive auxiliary agent contained in the first layer to a mass of the positive electrode mixture contained in the first layer.

According to this configuration, as the mass fraction of the conductive auxiliary agent in the second layer in the positive electrode mixture layer is high, an influence of a volume change of the positive electrode active material on the second layer is reduced, and generation of a gap and the like at a positive electrode interface is suppressed. Therefore, when used as a solid state battery, it is possible to make the influence of the volume change of the positive electrode active material less likely to occur.

An invention according to claim 2 of the present invention is the positive electrode according to claim 1, wherein the mass fraction of the conductive auxiliary agent contained in the second layer to the mass of the positive electrode mixture contained in the second layer is equal to or greater than 8 times and equal to or less than 10 times with respect to the mass fraction of the conductive auxiliary agent contained in the first layer to the mass of the positive electrode mixture contained in the first layer.

According to this configuration, it is possible to achieve both suppression of generation of a gap at the positive electrode interface when the volume change of the positive electrode active material occurs, and suppression of reduction in energy density.

An invention according to claim 3 of the present invention is the positive electrode according to claim 1, wherein a specific surface area of the conductive auxiliary agent contained in the second layer is equal to or greater than 150 m²/g and less than 800 m²/g.

According to this configuration, it is possible to achieve both suppression of generation of a gap at the positive electrode interface when the volume change of the positive electrode active material occurs, and realization of slurry of the positive electrode mixture based on ease of application to the metal porous body.

An invention according to claim 4 of the present invention is the positive electrode according to claim 1, wherein the positive electrode active material is MnO₂.

According to this configuration, the positive electrode in which the positive electrode active material is MnO₂ can be suitably used.

A solid state battery according to claim 5 of the present invention is a solid state battery including the positive electrode according to any one of claims 1 to 4, a solid electrolyte layer, and a negative electrode containing lithium.

According to this solid state battery, as the mass fraction of the conductive auxiliary agent in the second layer in the positive electrode mixture layer is high, an influence of a volume change of the positive electrode active material on the second layer is reduced, and generation of a gap and the like at a positive electrode interface is suppressed. Therefore, it is possible to make the influence of the volume change of the positive electrode active material less likely to occur.

A manufacturing method of a solid state battery according to claim 6 of the present invention is a manufacturing method of a solid state battery, the manufacturing method including: a step of applying a first positive electrode mixture containing a positive electrode active material, a solid electrolyte, and a conductive auxiliary agent to a first metal porous body; a step of applying a second positive electrode mixture containing a positive electrode active material, a solid electrolyte, and a conductive auxiliary agent to a second metal porous body; and a step of bonding the second metal porous body to a surface of the first metal porous body on a side of the solid electrolyte layer, wherein a mass fraction of the conductive auxiliary agent contained in the second positive electrode mixture to a mass of the second positive electrode mixture is greater than a mass fraction of the conductive auxiliary agent contained in the first positive electrode mixture to a mass of the first positive electrode mixture.

According to the solid state battery manufactured by this manufacturing method, as the mass fraction of the conductive auxiliary agent in the second positive electrode mixture is high, an influence of a volume change of the positive electrode active material on the second positive electrode mixture is reduced, and generation of a gap and the like at a positive electrode interface is suppressed. Therefore, it is possible to make the influence of the volume change of the positive electrode active material less likely to occur.

A manufacturing method of a solid state battery according to claim 7 of the present invention is a manufacturing method of a solid state battery, the manufacturing method including: a step of applying a first positive electrode mixture containing a positive electrode active material, a solid electrolyte, and a conductive auxiliary agent to a metal porous body; and a step of applying a second positive electrode mixture containing a positive electrode active material, a solid electrolyte, and a conductive auxiliary agent to a surface of the metal porous body on a side of the solid electrolyte layer, the metal porous body being applied with the first positive electrode mixture, wherein a mass fraction of the conductive auxiliary agent contained in the second positive electrode mixture to a mass of the second positive electrode mixture is greater than a mass fraction of the conductive auxiliary agent contained in the first positive electrode mixture to a mass of the first positive electrode mixture.

According to the solid state battery manufactured by this manufacturing method, as the mass fraction of the conductive auxiliary agent in the second positive electrode mixture is high, an influence of a volume change of the positive electrode active material on the second positive electrode mixture is reduced, and generation of a gap and the like at a positive electrode interface is suppressed. Therefore, it is possible to make the influence of the volume change of the positive electrode active material less likely to occur.

### BRIEF DESCRIPTION OF DRAWINGS

FIG. 1 is a sectional view schematically illustrating a solid state battery;

FIG. 2 is a diagram illustrating a capacity of the solid state battery for each C rate;

FIGS. 3A to 3C are views for explanation of a manufacturing method of a positive electrode;

FIGS. 4A and 4B are views for explanation of a first filling step and a second filling step in another manufacturing method of the solid state battery; and

FIG. 5 is a diagram illustrating a capacity of a coin type cell for each cycle in Example 1, Comparative Example 1, and Comparative Example 2.

### DETAILED DESCRIPTION

Hereinafter, a preferred embodiment of the present invention will be described in detail with reference to the accompanying drawings.

### Solid State Battery

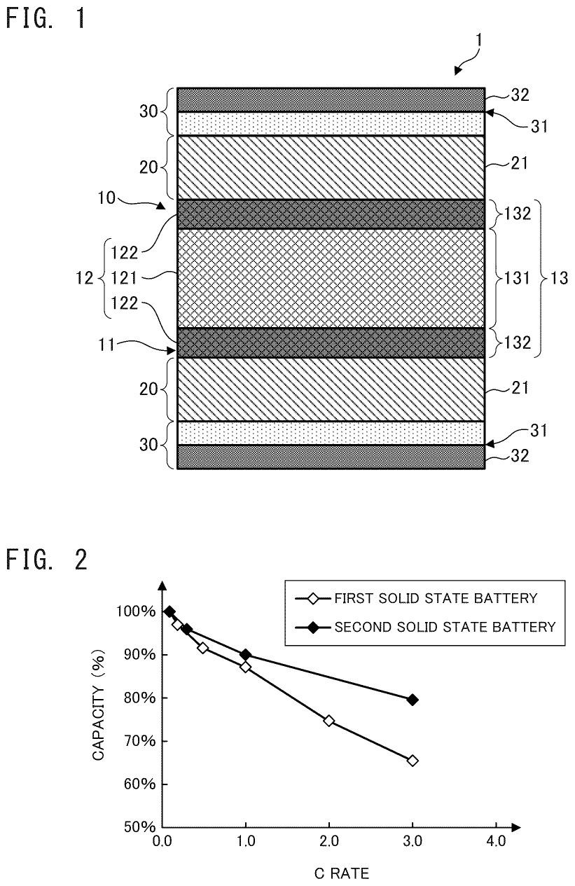

FIG. 1 is a sectional view schematically illustrating a solid state battery 1. A solid state battery of the present embodiment may have any of a coin type, a button type, a cylindrical type, a square type, and a laminate type. In addition, the solid state battery of the present embodiment is applicable to a wide range of applications such as mobile devices including mobile phones and laptop computers, and in-vehicle applications. FIG. 1 shows a solid state battery as a unit of cell.

The solid state battery 1 includes a positive electrode 10, a solid electrolyte layer 20, and a negative electrode 30. In the solid state battery 1 shown in FIG. 1, the negative electrode 30 is provided on each of an upper side and a lower side of the positive electrode 10, and the solid electrolyte layer 20 is provided on each of an upper side and a lower side of the positive electrode 10 so as to be sandwiched between each of the negative electrodes 30 and the positive electrode 10.

In the solid state battery 1 of the present embodiment, metal lithium is contained in the negative electrode 30, and lithium ions are occluded in the positive electrode active material contained in the positive electrode 10 when charging and discharging are repeated. When the negative electrode of the solid state battery contains metal lithium, an energy density of the solid state battery can be improved. On the other hand, when metal lithium is contained in the negative electrode, states of interfaces with the positive electrode and the negative electrode becomes unstable due to a structural change of the solid electrolyte layer accompanying charging and discharging.

In the solid state battery, the occurrence of destabilization of the interfaces associated with charging and discharging is considered to be caused by the following reasons and the like. When the positive electrode active material contained in the positive electrode occludes lithium ions, the volume of the positive electrode active material may be changed such that the positive electrode active material expands or the positive electrode active material crystallizes and contracts. When the volume of the positive electrode active material is changed, a gap is generated at the interface between the positive electrode and the solid electrolyte layer, so that lithium ions are hardly conducted at the interface, resistance is increased, and the interface is easily destabilized. In addition, as the positive electrode expands and contracts, a structural change occurs inside the positive electrode, the electronic path is interrupted, and the resistance increases.

On the other hand, since the positive electrode of the present embodiment is less likely to be affected by the volume change of the positive electrode active material, it is possible to suppress the destabilization of the interfaces even when charging and discharging are repeated.

### Positive Electrode

The positive electrode 10 includes a metal porous body 11 as a current collector and a positive electrode mixture 12.

The metal porous body 11 has pore portions continuous with each other. In the present embodiment, the positive electrode mixture 12 is filled in the pores of the metal porous body 11. Examples of the metal porous body include a mesh, a woven fabric, a nonwoven fabric, an embossed body, a punched body, an expanded body, and a foamed body. Examples of the metal used for the metal porous body include nickel, aluminum, stainless steel, titanium, and silver.

The positive electrode mixture 12 contains a positive electrode active material, a solid electrolyte, a binder, and a conductive auxiliary agent. Examples of the positive electrode active material include MnO₂ and sulfur that are materials containing no lithium, and MnO₂ is particularly preferable. In addition, MnO₂ is preferably of a ramsdellite-type, for example. When ramsdellite-type MnO₂ is used as the positive electrode active material, the energy density can be improved.

Here, in a case where the positive electrode active material is MnO₂, when charging and discharging are repeated as a solid state battery, the positive electrode active material occludes lithium ions and is crystallized, so that the positive electrode active material easily shrinks. For this reason, a gap tends to be easily generated at the interface between the positive electrode 10 and the solid electrolyte layer 20, and the interface tends to be unstable. On the other hand, in the positive electrode 10 of the present embodiment, since the current collector is the metal porous body 11, a gap is hardly generated at the interface.

The layer provided by filling the pores of the metal porous body 11 with the positive electrode mixture 12 is also regarded as a positive electrode mixture layer 13.

The positive electrode mixture 12 of the present embodiment includes a first positive electrode mixture 121 separated from the solid electrolyte layer 20 in the vertical direction in the drawing, and a second positive electrode mixture 122 disposed adjacent to the solid electrolyte layer 20 in the vertical direction between the solid electrolyte layer 20 and the first positive electrode mixture 121 in the vertical direction. The second positive electrode mixture 122 is provided on each of an upper side and a lower side of the first positive electrode mixture 121.

The layer provided by filling the pores of the metal porous body 11 with the first positive electrode mixture 121 is also regarded as a first positive electrode mixture layer 131. Further, the layer provided by filling the pores of the metal porous body 11 with the second positive electrode mixture 122 is also regarded as a second positive electrode mixture layer 132.

The first positive electrode mixture layer 131 preferably includes a positive electrode active material of equal to or greater than 65 parts by mass and equal to or less than 75 parts by mass, a solid electrolyte of equal to or greater than 23 parts by mass and equal to or less than 33 parts by mass, a binder of 1 part by mass, and a conductive auxiliary agent of 1 part by mass. A thickness of the first positive electrode mixture layer 131 is not particularly limited since various aspects are used depending on the specifications of the cell, but is preferably equal to or greater than 10 μm and equal to or less than 100 μm, for example.

The electric resistance of the first positive electrode mixture layer 131 is specified by impedance measurement. The electron conductivity of the first positive electrode mixture layer 131 is specified by measuring an electric resistivity of the first positive electrode mixture layer 131. Furthermore, the thickness and a density of the first positive electrode mixture layer 131 are specified by using a scanning electron microscope (SEM) after CP processing.

The second positive electrode mixture layer 132 preferably includes a positive electrode active material of equal to or greater than 60 parts by mass and equal to or less than 80 parts by mass, a solid electrolyte of equal to or greater than 8 parts by mass and equal to or less than 30 parts by mass, a binder of 1 part by mass, and a conductive auxiliary agent of equal to or greater than 8 parts by mass and equal to or less than 10 parts by mass. Further, a thickness of the second positive electrode mixture layer 132 is not particularly limited since various aspects are used depending on the specifications of the cell, but is preferably equal to or greater than 10 μm and equal to or less than 100 μm, for example.

A measuring method of an electric resistance, an electron conductivity, the thickness, and a density of the second positive electrode mixture layer 132 is the same as that for the first positive electrode mixture layer 131.

In the positive electrode 10 of the present embodiment, the mass fraction of the conductive auxiliary agent contained in the second positive electrode mixture 122 to the mass of the second positive electrode mixture 122 is greater than the mass fraction of the conductive auxiliary agent contained in the first positive electrode mixture 121 to the mass of the first positive electrode mixture 121. In this case, an influence due to the volume change of the positive electrode active material hardly occurs. In addition, when a ratio of the conductive auxiliary agent in the vicinity of the interface with the solid electrolyte layer 20 in the positive electrode 10 increases, even when the volume of the positive electrode active material changes, a gap is less likely to be generated at the interface due to the presence of the conductive auxiliary agent in the vicinity of the interface. Therefore, instability of the interface, such as disconnection of a movement path of electrons at the interface and an increase in resistance at the interface, is suppressed, and a solid state battery having high cycle characteristics is obtained. That is, in the present embodiment, in order to suppress generation of a gap at the interface between the positive electrode 10 and the solid electrolyte layer 20, the mass fraction of the conductive auxiliary agent in the second positive electrode mixture 122 is increased.

### Conductive Auxiliary Agent

Examples of the conductive auxiliary agent contained in the positive electrode mixture 12 include acetylene black (AB), furnace black (FB), thermal black, lamp black, channel black, roller black, disk black, carbon black (CB), carbon fiber, carbon nanotube (CNT), carbon nanohorn, graphite, graphene, glassy carbon, amorphous carbon, and the like.

### Binder

The binder is not particularly limited, and examples thereof include resin materials such as styrene butadiene rubber, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin.

### Solid Electrolyte Layer

The solid electrolyte layer 20 includes a solid electrolyte 21. Examples of the solid electrolyte 21 include a sulfide-based solid electrolyte material, an oxide-based solid electrolyte material, a halide-based solid electrolyte material, an inorganic solid electrolyte material such as a lithium-containing salt, a polymer-based solid electrolyte material such as polyethylene oxide, and a gel-based solid electrolyte material containing a lithium-containing salt or a lithium ion conductive ionic liquid. Examples of the sulfide-based solid electrolyte material include LPS-based halogen (Cl, Br, I), Li₂S—P₂S₅, Li₂S—P₂S₅-LiI, and the like. Note that the above description of “Li₂S—P₂S₅” means a sulfide-based solid electrolyte material obtained using a raw material composition containing Li₂S and P₂S₅, and the same applies to other descriptions. Examples of the oxide-based solid electrolyte material include NASICON-type oxide, garnet-type oxide, and perovskite-type oxide. Examples of the NASICON-type oxide include oxides containing Li, Al, Ti, P, and O (for example, Li_{1.5}A_{10.5}Ti_{1.5}(PO₄)₃). Examples of the garnet-type oxide include oxides containing Li, La, Zr, and O (for example, Li₇La₃Zr₂O₁₂). Examples of the perovskite-type oxide include oxides containing Li, La, Ti, and O (for example, LiLaTiO₃).

The solid electrolyte contained in the positive electrode mixture 12 may be the same material as the solid electrolyte 21 contained in the solid electrolyte layer 20.

The solid electrolyte layer 20 is preferably composed of the solid electrolyte 21 of equal to or greater than 90 parts by mass and equal to or less than 97 parts by mass and the binder of equal to or greater than 3 parts by mass and equal to or less than 10 parts by mass. In addition, a thickness of the solid electrolyte layer 20 is not particularly limited since various aspects are used depending on the specifications of the cell, but is preferably equal to or greater than 10 μm and equal to or less than 50 μm, for example.

A measuring method of an electric resistance, an electron conductivity, the thickness, and a density of the solid electrolyte layer 20 is the same as that of the positive electrode mixture layer 13.

A particle size of the solid electrolyte 21 is preferably greater than 0.5 μm and less than 5 μm. When the particle size of the solid electrolyte 21 is equal to or less than 0.5 μm, dispersion of the solid electrolyte 21 is likely to be insufficient when the slurry of the solid electrolyte 21 is adjusted, and it is difficult to apply the slurry since the viscosity of the slurry makes adjustment difficult. In addition, when the particle size of the solid electrolyte 21 is equal to or greater than 5 μm, unevenness is likely to occur in application of the solid electrolyte 21 to the metal porous body 11 because it is difficult for the solid electrolyte 21 to be uniformly provided in pores of the metal porous body 11. When unevenness occurs in application of the solid electrolyte 21 to the metal porous body 11, an electric resistance tends to increase.

### Negative Electrode

The negative electrode 30 includes a metal porous body 31 as a current collector and a vapor deposition portion 32.

The metal porous body 31 has pore portions continuous with each other. Examples of the metal porous body include a mesh, a woven fabric, a nonwoven fabric, an embossed body, a punched body, an expanded body, and a foamed body. Examples of the metal used for the metal porous body include nickel, aluminum, stainless steel, titanium, copper, and silver.

The vapor deposition portion 32 is a portion of metal deposited on a surface of the metal porous body 31. In the present embodiment, lithium metal is vapor-deposited on the metal porous body 31 to provide a thin film of lithium metal on the surface of the metal porous body 31, and thus an increase in electric resistance is suppressed. In the present embodiment, an amount of lithium metal corresponding to an upper limit of lithium ions that can be occluded by the positive electrode active material contained in the positive electrode mixture 12 is provided as the vapor deposition portion 32.

A thickness of the negative electrode 30 is not particularly limited since various aspects are used depending on the specifications of the cell, but is preferably equal to or greater than 10 μm and equal to or less than 50 μm, for example.

A measuring method of an electric resistance, an electron conductivity, the thickness, and a density of the negative electrode 30 is the same as that of the positive electrode mixture layer 13.

### Characteristics of Positive Electrode

Next, the characteristic configuration of the positive electrode 10 in the solid state battery 1 of the present embodiment will be described.

### Mass Fraction of Conductive Auxiliary Agent

In the present embodiment, the mass fraction of the conductive auxiliary agent contained in the second positive electrode mixture 122 to the mass of the second positive electrode mixture 122 is preferably equal to or greater than 8 times and equal to or less than 10 times of the mass fraction of the conductive auxiliary agent contained in the first positive electrode mixture 121 to the mass of the first positive electrode mixture 121. Note that a magnification ratio of the mass fraction of the conductive auxiliary agent contained in the second positive electrode mixture 122 to the mass of the conductive auxiliary agent contained in the second positive electrode mixture 122 with respect to the mass fraction of the first positive electrode mixture 121 to the mass of the conductive auxiliary agent contained in the first positive electrode mixture 121 may be hereinafter referred to as a magnification ratio of the conductive auxiliary agent of the second positive electrode mixture 122 to the conductive auxiliary agent of the first positive electrode mixture 121.

When the magnification ratio of the conductive auxiliary agent of the second positive electrode mixture 122 to the conductive auxiliary agent of the first positive electrode mixture 121 is less than 8 times, the occurrence of a gap at the interface between the positive electrode 10 and the solid electrolyte layer 20 may not be sufficiently suppressed by an amount of the conductive auxiliary agent of the second positive electrode mixture 122 being insufficient.

When the magnification ratio of the conductive auxiliary agent of the second positive electrode mixture 122 to the conductive auxiliary agent of the first positive electrode mixture 121 is larger than 10 times, there is a possibility that the capacity of the positive electrode 10 decreases and the energy density of the solid state battery 1 decreases by the amount of the conductive auxiliary agent contained in the second positive electrode mixture layer 132 being excessive. In addition, in the manufacturing of the slurry of the second positive electrode mixture 122, kneading and applying of the slurry are likely to be difficult as the conductive auxiliary agent having a high specific surface area is likely to absorb the solvent. (Specific surface area of conductive auxiliary agent)

The specific surface area of the conductive auxiliary agent contained in the positive electrode mixture 12 is preferably equal to or greater than 150 m²/g and less than 800 m²/g, and more preferably equal to or greater than 300 m²/g and less than 800 m²/g.

When the specific surface area of the conductive auxiliary agent is less than 150 m²/g, the suppression of the generation of the gap at the interface between the positive electrode 10 and the solid electrolyte layer 20 may not be sufficient because the conductive auxiliary agent is less likely to come into contact with the particles of the positive electrode mixture 12. In addition, when the specific surface area of the conductive auxiliary agent is equal to or greater than 800 m²/g, in the production of the slurry of the positive electrode mixture 12, the aggregate of the conductive auxiliary agent grows due to the intermolecular force between the particles of the conductive auxiliary agent, the viscosity of the slurry of the positive electrode mixture 12 increases, and the like, so that it becomes difficult to apply the slurry to the metal porous body 11.

FIG. 2 is a diagram showing a relationship between a C rate and a capacity of a solid state battery of a first solid state battery and a second solid state battery, each including a positive electrode mixture containing a different conductive auxiliary agent.

In the first solid state battery, the mass fraction of the conductive auxiliary agent contained in the first positive electrode mixture 121 to the mass of the first positive electrode mixture 121 is 1 wt %, and the mass fraction of the conductive auxiliary agent contained in the second positive electrode mixture 122 to the mass of the second positive electrode mixture 122 is 2.5 wt %. That is, in the first solid state battery, the magnification ratio of the conductive auxiliary agent of the second positive electrode mixture 122 to the conductive auxiliary agent of the first positive electrode mixture 121 is 2.5 times. In the first solid state battery, the specific surface area of the conductive auxiliary agent contained in the positive electrode mixture 12 is 45 m²/g.

In the second solid state battery, the mass fraction of the conductive auxiliary agent contained in the first positive electrode mixture 121 to the mass of the first positive electrode mixture 121 is 1 wt %, and the mass fraction of the conductive auxiliary agent contained in the second positive electrode mixture 122 to the mass of the second positive electrode mixture 122 is 8.0 wt %. That is, in the second solid state battery, the magnification ratio of the conductive auxiliary agent of the second positive electrode mixture 122 to the conductive auxiliary agent of the first positive electrode mixture 121 is 8 times. In the second solid state battery, the specific surface area of the conductive auxiliary agent contained in the positive electrode mixture 12 is 300 m²/g.

Using the first solid state battery and the second solid state battery described above, a charging and discharging test was performed at a 0.05 C rate and a cutoff potential of 2.0 V to 4.0 V under a temperature condition of 60° C. The above operation was performed at each of C rates of 0.5 C, 1.0 C, 2.0 C, and 3.0 C, the capacity when charging and discharging were performed was measured for each of the C rates, and the measurement results are shown in FIG. 2. The capacity shown in FIG. 2 is the ratio of the capacity after charging and discharging at each of the C rates to the capacity before charging and discharging.

In the second solid state battery, as compared with the first solid state battery, the capacity tends to be less likely to decrease even when the C rate is increased, and it was confirmed that the high capacity is maintained even when the C rate is high. From this result, it is found that the solid state battery 1 including the positive electrode 10 in which the magnification ratio of the conductive auxiliary agent of the second positive electrode mixture 122 to the conductive auxiliary agent of the first positive electrode mixture 121 is equal to or greater than 8 times or the positive electrode 10 in which the specific surface area of the conductive auxiliary agent contained in the positive electrode mixture 12 is equal to or greater than 150 m²/g is less likely to be affected by the volume change of the positive electrode active material, and has excellent durability (charge and discharge cycle characteristics).

### Manufacturing Method of Solid State Battery

Next, a manufacturing method of the solid state battery 1 will be described.

The solid state battery 1 of the present embodiment is manufactured by a positive electrode manufacturing step of manufacturing the positive electrode 10, a first lamination step of laminating the solid electrolyte layer 20 on the positive electrode 10, and a second lamination step of laminating the negative electrode 30 on the laminated body. The positive electrode manufacturing step includes a slurry manufacturing step of manufacturing a slurry of the positive electrode mixture 12, a first filling step of filling and applying the first positive electrode mixture 121 into pores of a first metal porous body 111 to be described later, a second filling step of filling and applying the second positive electrode mixture 122 into pores of a second metal porous body 112 to be described later, and a joining step of joining the first metal porous body 111 and the second metal porous body 112.

### Slurry Manufacturing Step

In the manufacturing of the positive electrode 10, first, a slurry of the positive electrode mixture 12 containing a positive electrode active material, a solid electrolyte, a conductive auxiliary agent, a binder, and a solvent is manufactured. In the present embodiment, two types of slurries, namely, a slurry of the first positive electrode mixture 121 and a slurry of the second positive electrode mixture 122 are manufactured.

### First Filling Step

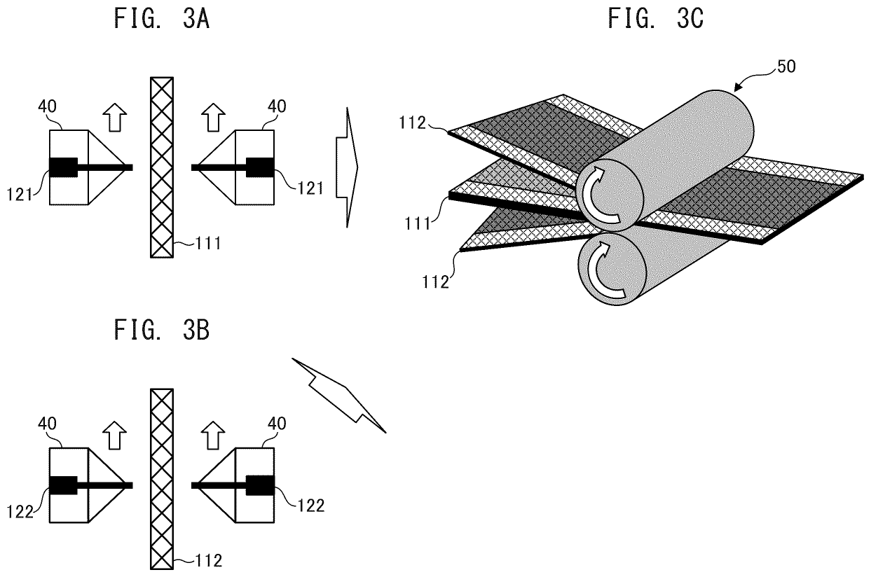

FIG. 3A is a diagram for explanation of the first filling step.

Next, the slurry of the positive electrode mixture 12 is filled and applied in the pores of the metal porous body 11. In the present embodiment, as the metal porous body 11, a first metal porous body 111 filled and applied with the slurry of the first positive electrode mixture 121 and a second metal porous body 112 filled and applied with the slurry of the second positive electrode mixture 122 are used.

As shown in FIG. 3A, two coaters 40 are used for filling and applying the first positive electrode mixture 121 into the pores of the first metal porous body 111. Within the two coaters 40, a slurry of the first positive electrode mixture 121 is filled. The coaters 40 are provided on both outer sides in the thickness direction of the first metal porous body 111, and the slurry is filled and applied in the pores of the first metal porous body 111 by the coaters discharging the slurry of the first positive electrode mixture 121 to both surfaces of the first metal porous body 111. In addition, the coaters 40 discharge the slurry while moving in the longitudinal direction (the vertical direction in the illustrated example) of the first metal porous body 111, and thus perform filling and applying of the slurry of the first positive electrode mixture 121 in the longitudinal direction of the first metal porous body 111. Here, the slurry of the first positive electrode mixture 121 is filled and applied to one first metal porous body 111.

### Second Filling Step

FIG. 3B is a diagram for explanation of the second filling step. As shown in FIG. 3B, two coaters 40 are also used for filling and applying the second positive electrode mixture 122 into the pores of the second metal porous body 112. Within the two coaters 40, a slurry of the second positive electrode mixture 122 is filled. The coaters 40 are provided on both outer sides in the thickness direction of the second metal porous body 112, and the slurry is filled and applied in the pores of the second metal porous body 112 by the coaters discharging the slurry of the second positive electrode mixture 122 to both surfaces of the second metal porous body 112. In addition, the coaters 40 discharge the slurry while moving in the longitudinal direction of the second metal porous body 112, and thus perform filling and applying of the slurry of the second positive electrode mixture 122 in the longitudinal direction of the second metal porous body 112. Here, the slurry of the second positive electrode mixture 122 is filled and applied to two second metal porous bodies 112.

Thereafter, the one first metal porous body 111 and the two second metal porous bodies 112 to which the slurry is filled and applied are dried.

### Joining Step

FIG. 3C is a diagram for explanation of the joining step. As shown in FIG. 3C, the second metal porous body 112 is overlaid on both surfaces of the first metal porous body 111. Then, in this state, the first metal porous body 111 and the second metal porous body 112 are pressurized while being sandwiched by the roll press 50 which is a pressurizing device. As a result, the one first metal porous body 111 and the two second metal porous bodies 112 are joined to each other in a state in which a filling density of the first positive electrode mixture 121 and the second positive electrode mixture 122 is improved, and thus one metal porous body 11 is produced. In this way, the positive electrode 10 (see FIG. 1) in which the first positive electrode mixture layer 131 is sandwiched between the second positive electrode mixture layers 132 is manufactured.

Thereafter, the solid electrolyte layers 20 are laminated on both surfaces of the positive electrode 10, and then pressurized by roll pressing to provide a laminated body. Further, the negative electrode 30 is laminated on both surfaces of the laminated body, and then pressurized by roll pressing. Thus, the solid state battery 1 shown in FIG. 1 is manufactured.

### Another Manufacturing Method of Solid State Battery

Next, another manufacturing method of the solid state battery 1 will be described. The manufacturing method of the solid state battery 1 according to the present embodiment is not limited to the example shown in FIGS. 3A to 3C.

In another manufacturing method of solid state battery 1 described below, the first filling step and the second filling step in the positive electrode manufacturing step are different from the above-described manufacturing method of the solid state battery 1. In the another manufacturing method of the solid state battery 1 described below, the joining step is not provided in the positive electrode manufacturing step. Further, in the another manufacturing method of the solid state battery 1 described below, the slurry manufacturing step, the first lamination step, and the second lamination step in the positive electrode manufacturing step are the same as the manufacturing method of the solid state battery 1 described above.

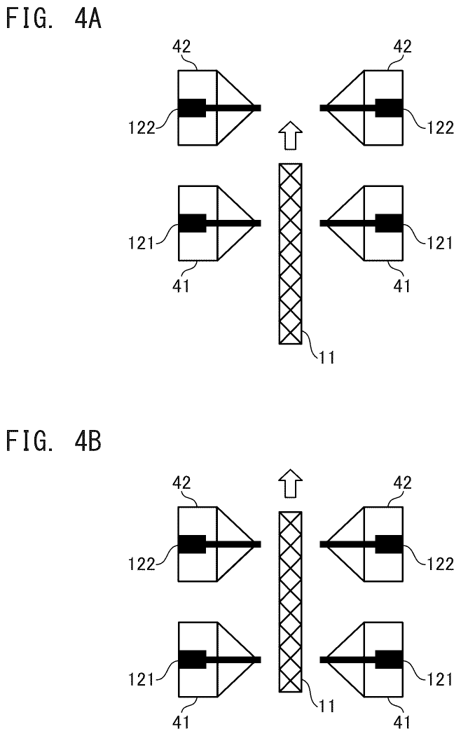

FIGS. 4A and 4B are views for explanation of the first filling step and the second filling step in the another manufacturing method of the solid state battery 1.

In the first filling step and the second filling step in the another manufacturing method of the solid state battery 1, the slurry of the first positive electrode mixture 121 and the slurry of the second positive electrode mixture 122 are filled and applied on one metal porous body 11.

As shown in FIG. 4A, two first coaters 41 are used for filling and applying the first positive electrode mixture 121 into the pores of the metal porous body 11. Within the two first coaters 41, a slurry of the first positive electrode mixture 121 is filled. In addition, the two first coaters 41 face each other in the left-right direction in the drawing and are provided at intervals in the left-right direction.

Further, two second coaters 42 are used for filling and applying the second positive electrode mixture 122 into the pores of the metal porous body 11. Within the two second coaters 42, a slurry of the second positive electrode mixture 122 is filled. In addition, the two second coaters 42 face each other in the left-right direction in the drawing and are provided at intervals in the left-right direction.

Metal porous body 11 reaches a position between two first coaters 41 by moving from a lower side to an upper side of first coaters 41. At this time, the two first coaters 41 discharge the slurry of the first positive electrode mixture 121 to both surfaces of the metal porous body 11 to fill and apply the pores of the metal porous body 11 with the slurry. When the metal porous body 11 moves upward while the slurry is discharged from the first coaters 41, the slurry of the first positive electrode mixture 121 is filled in the longitudinal direction of the metal porous body 11. On the other hand, the metal porous body 11 does not reach the second coaters 42.

Next, as the metal porous body 11 continues to move upward, it reaches a position between the two second coaters 42 as shown in FIG. 4B. At this time, the two second coaters 42 discharge the slurry of the second positive electrode mixture 122 to both surfaces of the metal porous body 11, so that the slurry of the second positive electrode mixture 122 is filled and applied to a portion located outside the portion where the first positive electrode mixture 121 is filled and applied in the left-right direction in the pores of the metal porous body 11. When the metal porous body 11 moves upward while the slurry is being discharged from the second coaters 42, the slurry of the second positive electrode mixture 122 is filled and applied on the outer side in the left-right direction than the portion of the metal porous body 11 where the slurry of the first positive electrode mixture 121 is filled and applied over the longitudinal direction of the metal porous body 11.

The first coaters 41 may discharge the slurry to the metal porous body 11 at a higher pressure than the second coaters 42. In this way, the slurry of the first positive electrode mixture 121 is filled and applied to a central portion in the left-right direction in the pores of the metal porous body 11.

In the example described above, the metal porous body 11 is provided so as to move, but the present invention is not limited thereto. As the first coaters 41 and the second coaters 42 move, the slurry of the first positive electrode mixture 121 and the slurry of the second positive electrode mixture 122 may be filled over the longitudinal direction of the metal porous body 11.

Next, the metal porous body 11 is dried and then pressurized by roll pressing, so that the filling density of the first positive electrode mixture 121 and the second positive electrode mixture 122 is improved, and the positive electrode 10 (see FIG. 1) in which the first positive electrode mixture layer 131 is sandwiched between the second positive electrode mixture layers 132 is manufactured.

### EXAMPLES

Next, examples of the present invention will be described, but the present invention is not limited to the examples below.

### Example 1

### (Production of Coin Type Cell (Solid State Battery))

A slurry (see FIG. 1) of the first positive electrode mixture 121 was prepared using ramsdellite-type MnO₂ of 65 parts by mass as a positive electrode active material, a solid electrolyte of 33 parts by mass, a binder of 1 part by mass, and a conductive auxiliary agent of 1 part by mass, the conductive auxiliary agent having a specific surface area of 300 m²/g. Next, the obtained slurry was filled and applied on the one first metal porous body 111 made of aluminum by the method shown in FIG. 3A as the first filling step.

Next, a slurry of a second positive electrode mixture 122 was prepared using ramsdellite-type MnO₂ of 60 parts by mass as a positive electrode active material, a solid electrolyte of 30 parts by mass, a binder of 2 part by mass, and a conductive auxiliary agent of 8 part by mass, the conductive auxiliary agent having a specific surface area of 300 m²/g. Next, the obtained slurry was filled and applied on the one second metal porous body 112 made of aluminum by the method shown in FIG. 3B as the second filling step.

Next, the second metal porous body 112 was laminated on the first metal porous body 111, and pressurized by the method shown in FIG. 3C as the joining step to prepare a positive electrode having a basis weight of 30 mg/cm² and having the first positive electrode mixture layer 131 and the second positive electrode mixture layer 132 provided thereon.

Next, a slurry of the solid electrolyte was prepared using the solid electrolyte of 90 parts by mass and the binder of 10 parts by mass, and the obtained slurry was applied to the positive electrode, dried, and then pressurized by roll pressing to prepare a laminated body in which the solid electrolyte layer 20 was laminated on the positive electrode.

Next, lithium metal was deposited on the surface of the metal porous body 31 (see FIG. 1) made of copper to produce the negative electrode 30 on which the vapor deposition portion 32 was provided. Then, the prepared negative electrode 30 was laminated on the laminated body in which the solid electrolyte layer 20 was laminated on the positive electrode, dried, and then pressurized by roll pressing to prepare a coin type cell of Example 1 having a diameter of 10 mm as a solid state battery.

### Comparative Example 1

A slurry of a positive electrode mixture was prepared using the ramsdellite-type MnO₂ of 65 parts by mass as the positive electrode active material, the solid electrolyte of 33 parts by mass, the binder of 1 part by mass, and the conductive auxiliary agent of 1 part by mass, the conductive auxiliary agent having a specific surface area of 45 m²/g. Next, the obtained slurry was laminated on an aluminum foil as a current collector, dried, and then pressurized by roll pressing to prepare a positive electrode having a basis weight of 30 mg/cm².

Next, a slurry of the solid electrolyte was prepared using the solid electrolyte of 90 parts by mass and the binder of 10 parts by mass, and the obtained slurry was applied to the positive electrode, dried, and then pressurized by roll pressing to prepare a laminated body in which the solid electrolyte layer was laminated on the positive electrode.

Next, a negative electrode provided by laminating a copper foil as a current collector on a surface of lithium metal was prepared. Then, the prepared negative electrode was laminated on the laminated body in which the solid electrolyte layer was laminated on the positive electrode, dried, and then pressurized by roll pressing to prepare a coin type cell of Comparative Example 1 having a diameter of 10 mm as a solid state battery. The positive electrode of the coin type cell is composed of a single positive electrode mixture layer.

### Comparative Example 2

A slurry of a positive electrode mixture was prepared using the ramsdellite-type MnO₂ of 65 parts by mass as the positive electrode active material, the solid electrolyte of 33 parts by mass, the binder of 1 part by mass, and the conductive auxiliary agent of 1 part by mass, the conductive auxiliary agent having a specific surface area of 45 m²/g. Next, the obtained slurry was filled and applied in the pores of the metal porous body made of aluminum by the method shown in FIG. 3A. Thereafter, the metal porous body was dried and then pressurized by roll pressing to produce a positive electrode having a basis weight of 30 mg/cm².

Next, a solid electrolyte layer and a negative electrode were provided on the obtained positive electrode in the same manner as in Example 1, and then a coin type cell of Comparative Example 2 having a diameter of 10 mm is prepared. The positive electrode of this coin type cell is common to Example 1 in that the positive electrode mixture is filled in the pores of the metal porous body, but is different from Example 1 in that the positive electrode includes a single positive electrode mixture layer, that is, the second positive electrode mixture layer 132 (see FIG. 1) is not provided in the positive electrode.

### Evaluation of Coin Type Cell

Using the obtained coin type cell, a charging and discharging test was performed at a 0.05 C rate and a cutoff potential of 2.0 V to 4.0 V under a temperature condition of 60° C. The above operation was performed at each of C rates of 1.0 C, 2.0 C, and 3.0 C, and the capacity when charged and discharged was measured for each cycle.

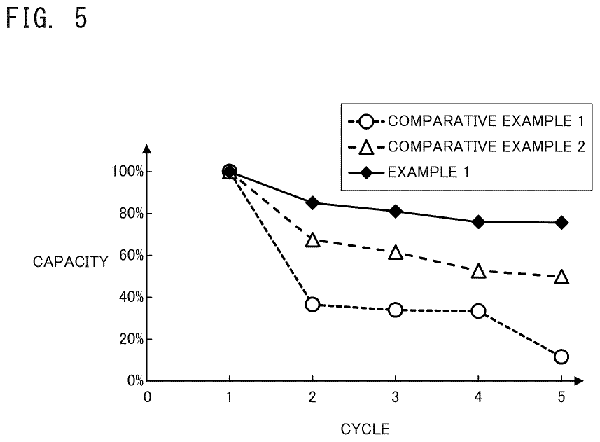

FIG. 5 is a diagram showing the capacity of the coin type cell for each cycle when charged and discharged at a 0.05 C rate for 5 cycles in Example 1, Comparative Example 1, and Comparative Example 2. The capacity illustrated in FIG. 5 is a ratio of the capacity of the coin type cell after charging and discharging to the capacity of the coin type cell before charging and discharging.

In Example 1, as compared with Comparative Example 1 and Comparative Example 2, the capacity tended to be less likely to decrease even when the number of cycles was increased, and it was confirmed that a high capacity was maintained even when the number of cycles was increased. From this, it is found that in the solid state battery in which the positive electrode mixture layer having a conductive auxiliary agent of a high mass fraction is provided on the solid electrolyte layer side, it is possible to obtain results that the presence of the conductive auxiliary agent in the vicinity of the positive electrode interface makes it difficult for an influence of the volume change of the positive electrode active material to occur, and excellent durability (charge and discharge cycle characteristics) is provided.

From the above results, according to the present invention, it was found that it is possible to provide a positive electrode which is hardly affected by a volume change of the positive electrode active material.

What is claimed is:

1. A positive electrode of a solid state battery, the positive electrode comprising:
a positive electrode mixture layer provided by filling pores of a metal porous body with a positive electrode mixture containing a positive electrode active material, a solid electrolyte, and a conductive auxiliary agent, wherein
the positive electrode mixture layer includes a first layer and a second layer provided closer to the solid electrolyte layer than the first layer is, and
a mass fraction of the conductive auxiliary agent contained in the second layer to a mass of the positive electrode mixture contained in the second layer is greater than a mass fraction of the conductive auxiliary agent contained in the first layer to a mass of the positive electrode mixture contained in the first layer.

2. The positive electrode according to claim 1, wherein the mass fraction of the conductive auxiliary agent contained in the second layer to the mass of the positive electrode mixture contained in the second layer is equal to or greater than 8 times and equal to or less than 10 times with respect to the mass fraction of the conductive auxiliary agent contained in the first layer to the mass of the positive electrode mixture contained in the first layer.

3. The positive electrode according to claim 1, wherein a specific surface area of the conductive auxiliary agent contained in the second layer is equal to or greater than

150. m²/g and less than 800 m²/g.

4. The positive electrode according to claim 1, wherein the positive electrode active material is MnO₂.

5. A solid state battery comprising: the positive electrode according to claim 1; a solid electrolyte layer; and a negative electrode containing lithium.

6. A manufacturing method of a solid state battery, the manufacturing method comprising:
a step of applying a first positive electrode mixture containing a positive electrode active material, a solid electrolyte, and a conductive auxiliary agent to a first metal porous body;
a step of applying a second positive electrode mixture containing a positive electrode active material, a solid electrolyte, and a conductive auxiliary agent to a second metal porous body; and
a step of bonding the second metal porous body to a surface of the first metal porous body on a side of the solid electrolyte layer, wherein
a mass fraction of the conductive auxiliary agent contained in the second positive electrode mixture to a mass of the second positive electrode mixture is greater than a mass fraction of the conductive auxiliary agent contained in the first positive electrode mixture to a mass of the first positive electrode mixture.

7. A manufacturing method of a solid state battery, the manufacturing method comprising:
a step of applying a first positive electrode mixture containing a positive electrode active material, a solid electrolyte, and a conductive auxiliary agent to a metal porous body; and
a step of applying a second positive electrode mixture containing a positive electrode active material, a solid electrolyte, and a conductive auxiliary agent to a surface of the metal porous body on a side of the solid electrolyte layer, the metal porous body being applied with the first positive electrode mixture, wherein
a mass fraction of the conductive auxiliary agent contained in the second positive electrode mixture to a mass of the second positive electrode mixture is greater than a mass fraction of the conductive auxiliary agent contained in the first positive electrode mixture to a mass of the first positive electrode mixture.
